(19) United States
(12) Patent Application Publication
(10) Pub. No.: US 2012/0168383 A1
(43) Pub. Date: Jul. 5, 2012

(54) GRAPHENE-IRON OXIDE COMPLEX AND FABRICATION METHOD THEREOF

(75) Inventors: Hye Young KOO, Jeollabuk-Do (KR); Won San CHOI, Jeollabuk-Do (KR); Jun Kyung KIM, Seoul (KR)

(73) Assignee: KOREA INSTITUTE OF SCIENCE AND TECHNOLOGY, Seoul (KR)

(21) Appl. No.: 13/230,993

(22) Filed: Sep. 13, 2011

(30) Foreign Application Priority Data
Dec. 29, 2010 (KR) 10-2010-0138158

(51) Int. Cl. C02F 1/62; C02F 1/28; C01G 49/00; B32B 3/00; B82Y 40/00; B82Y 30/00

(52) U.S. Cl. 210/688; 423/415.1; 428/141; 210/502.1; 977/734; 977/847; 977/903

(57) ABSTRACT

A graphene-iron oxide complex consists of graphene and needle-like iron oxide nanoparticles grown on a surface of the graphene, and a fabricating method thereof includes (A) preparing a reduced graphene dispersed solution, (B) mixing the dispersed solution with a solution containing iron oxide precursors to prepare a mixture, (C) stirring the mixture to prepare a graphene-iron oxide dispersed solution containing the graphene-iron oxide complex that needle-like iron oxide nanoparticles are grown on the surface of the graphene, and (D) separating the graphene-iron oxide complex from the graphene-iron oxide complex dispersed solution.

### CROSS-REFERENCE TO RELATED APPLICATION

This application claims the benefit of Korean Patent Application No. 10-2010-0138158, filed on Dec. 29, 2010, which is hereby incorporated by reference for all purposes as if fully set forth herein.

### BACKGROUND OF THE INVENTION

1. Field of the Invention

This specification relates to a graphene-iron oxide complex and a fabrication method thereof, and particularly, to a graphene-iron oxide complex useable as a filtration (purification) filter for removal of heavy metals and a fabrication method thereof.

2. Background of the Invention

Various types of metal oxide such as iron oxide, titanium oxide or the like are specifically bound to heavy metal ion. Hence, in order to utilize such metal oxide based materials as a heavy metal remover with high efficiency, they are processed into nanoparticles or the like.

However, even when processed into the nanoparticles or the like, they still have a limit to a specific surface area, which causes a limit to improvement of efficiency of heavy metal removal. Therefore, efforts to utilize new types of structures having a high specific surface area to remove heavy metals are required.

Also, in order to apply the metal oxide based materials to purification (filtration) through consecutive processes, structural flexibility is required to make up for disadvantages of the metal oxide based materials, such as breaking of a structure or the like, even when being exposed to a high flow rate of heavy metal-contaminated water.

Consequently, there are demands on the fabrication of a heavy metal remover having a high specific surface area as well as flexibility. Also, after adsorption of heavy metals, processes such as recycling and the like should be carried out, the metal oxide materials may preferably have a selective separation characteristic to effectively separate the heavy metal-absorbed heavy metal remover.

### SUMMARY OF THE INVENTION

Therefore, an aspect of the detailed description is to provide a heavy metal remover (absorbent) capable of absorbing heavy metals, in order to remove heavy metal ions from water contaminated by the heavy metals, and more particularly, a graphene-iron oxide complex with a high specific surface area for effective adsorption of the heavy metals.

Another aspect of the detailed description is to ensure flexibility of the heavy metal remover to minimize or prevent a structure from being broken or damaged due to high hydraulic pressure caused by a high velocity of flow.

Also, after absorption of heavy metals, an effective separation and a recycling process should be followed, so another aspect of the detailed description is to effectively selectively separate a heavy metal remover to which heavy metals are absorbed.

That is, another aspect of the detailed description is to provide a graphene-iron oxide complex simultaneously having characteristics of an effective adsorption of heavy metals by virtue of a high specific surface area, guarantee of flexibility and an effective selective separation, and a fabrication method thereof.

To achieve these and other advantages and in accordance with the purpose of this specification, as embodied and broadly described herein, a graphene-iron oxide complex may include graphene and iron oxide nanoparticles formed in a needle-like shape on the surface of the graphene, and a fabrication method thereof may include (A) preparing a reduced graphene dispersed solution, (B) mixing the dispersed solution with a solution containing iron oxide precursors to prepare a mixture, (C) stirring the mixture to prepare a graphene-iron oxide complex dispersed solution containing the graphene-iron oxide complex that needle-like iron oxide nanoparticles are grown on the surface of the graphene, and (D) separating the graphene-iron oxide complex from the graphene-iron oxide complex dispersed solution.

In accordance with this specification, a method for removing heavy metals may be configured by bonding the thusly-fabricated graphene-iron oxide complex to heavy metals contained in contaminated water, forming a magnetic field, and separating the graphene-iron oxide complex bonded with the heavy metals.

In accordance with this specification, a method for fabricating a purification (filtration) filter for removal of heavy metals may employ the thusly-fabricated graphene-iron oxide complex as a membrane filter.

This specification provides a heavy metal remover, which has flexibility of graphene and an increased adsorption by virtue of a high specific surface area of needle-like iron oxide nanoparticles, and is able to be effectively selectively separated by formation of a magnetic field after adsorption of heavy metals by virtue of superparamagnetism of the iron oxide.

Also, in accordance with the fabrication method, the needle-like iron oxide nanoparticles grown on surfaces of graphene sheets can be adjusted in length by changing a reaction condition and a reaction time (the number of process repetition), which facilitates adjustment of properties, such as a specific surface area, an electroconductivity, a heavy metal removal capacity and the like, of the graphene-iron oxide complex, which is the final product.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIGS. 1A to 1C show Scanning Electron Microscopic (SEM) photos of graphene-iron oxide complexes fabricated in Example 1 (FIG. 1A), Example 2 (FIG. 1B) and Example 3 (FIG. 1C);

FIGS. 2A to 2C show Transmission Electron Microscopic (TEM) photos of graphene-iron oxide complexes fabricated in Example 1 (FIG. 2A), Example 2 (FIG. 2B) and Example 3 (FIG. 2C);

FIG. 3 shows an electron diffraction pattern of a selected area of Example 1;

FIGS. 4A and 4B show photos of purification (filtration) filters for removal of heavy metals fabricated using the graphene-iron oxide complexes, which show the filtration filter for removal of heavy metals fabricated in Example 4 (FIG. 4A) and that fabricated in Example 5 (FIG. 4B);

FIG. 5 shows a photo exhibiting the purification filter for removal of heavy metals is stuck to a magnet;

FIG. 6 is a graph showing results of Raman analysis for the graphene-iron oxide complexes;

FIG. 7 is a graph showing test results of removal of heavy metals using the graphene-iron oxide complexes;

FIG. 8 is a photo showing a process of removing (separating) the graphene-iron oxide complex, to which heavy metals are absorbed, using a magnet; and

FIG. 9 shows the changes in concentrations of heavy metal ions within a chrome ion solution and related photos when employing the purification (filtration) filter for removal of heavy metals using the graphene-iron oxide complex.

### DETAILED DESCRIPTION OF THE INVENTION

A complex of graphene iron oxide (graphene-iron oxide complex) according to this specification may contain graphene and needle-like iron oxide nanoparticles grown on the surface of the graphene. As the needle-like iron oxide nanoparticles are grown on the surface of the graphene, a specific surface area may be greatly increased, accordingly, a surface on which the iron oxide contacts heavy metals can be increased, resulting in remarkable improvement of adsorption capability.

The needle-like iron oxide nanoparticle may be 10 to 500 nm long. The specific surface area of the graphene-iron oxide complex may be more than 200 m²/g. The length and the specific surface area of the needle-like iron oxide nanoparticle may be easily adjusted by the number of repetition of the following steps (B) and (C).

A purification filter for removal of heavy metals according to this specification may employ the graphene-iron oxide complex as a membrane filter.

A fabrication method for a graphene-iron oxide complex according to this specification may include (A) preparing a reduced graphene dispersed solution, (B) mixing the dispersed solution with a solution containing iron oxide precursors to prepare a mixture, (C) stirring the mixture to prepare a graphene-iron oxide dispersed solution containing the graphene-iron oxide complex that needle-like iron oxide nanoparticles are grown on the surface of the graphene, and (D) separating the graphene-iron oxide complex from the graphene-iron oxide complex dispersed solution.

The step (A) may be configured to fabricate a graphite oxide by treating graphite using a strong acid, treating the graphite oxide using ultrasonic waves, followed by reduction, and preparing a reduced graphene dispersed solution.

The iron oxide precursor may be iron pyrite (II) or iron pyrite (III).

Prior to the step (D), the steps (C) and (D) may be repeated so as to facilitate adjustment of a length of the needle-like iron oxide nanoparticle and a specific surface area of the graphene-iron oxide complex.

A method for removing heavy metals according to this specification may be configured to bond the thusly-fabricated graphene-iron oxide complex to heavy metals contained in contaminated water, form a magnetic field, and separate the heavy metal-bonded graphene-iron oxide complex. The heavy metal-bonded graphene-iron oxide complex may experience a collection for recycling. The heavy metal-bonded graphene-iron oxide complex can be easily separated and collected only by forming the magnetic field by virtue of superparamagnetism of the iron oxide.

A method for fabricating a purification (filtration) filter for removal of heavy metals according to this specification may employ the thusly-fabricated graphene-iron oxide complex as a membrane filter.

A method for removing heavy metals according to this specification may be configured to remove heavy metals by rendering contaminated water containing heavy metals flow through the thusly-fabricated purification filter for removal of heavy metals in a contact state with each other.

### EXAMPLES

Hereinafter, description will be given in more detail of Examples of this specification. The examples are merely illustrative, and should not be construed to limit this specification.

Synthesis of Graphite Oxide Powder

1 g of graphite powder was added in 23 mL of sulfuric acid solution, which was made cooled, to be stirred. 3 g of potassium permanganate (KMnO₄) were added in the solution and stirred very slowly to prevent a temperature change from exceeding 20° C. The mixture was continuously stirred at room temperature for 30 minutes, followed by addition of 23 mL of distilled water thereto. Distilled water was added to the mixture with attention to maintaining temperature below 95° C. After 15 minutes, the distilled water was poured in the mixture and 10 mL of 30% hydrogen peroxide solution (H₂O₂) was added. After reaction for full 24 hours, acids and metal ions, which were not participated in the reaction, were removed through dialysis. The dialysis was continuously carried out until pH of the final product reaches 7. After complete dialysis, graphite powder were finally obtained through centrifugation and lyophilization.

Synthesis of Graphene Nano Sheet

First of all, 30 mg of graphite powder were mixed with 30 mL of distilled water to be treated with ultrasonic waves for 1 hour. For reduction of the graphite oxide, the mixture was mixed with 0.2 mL of hydrogen and 30 mL of 10 mg/mL aqueous solution of polystyrene sulfonate (PSS). The reduction was carried out at temperature of 100° C. Water refluxing and nitrogen purging were all carried out. After the reaction for full 24 hours, the final reactant was centrifuged, followed by filtering, thereby obtaining graphene nano sheets.

Fabrication of Graphene-Iron Oxide Complex

A mixture, in which 5 mL of 1.9 10⁻⁵ M FeSO₄ aqueous solution and 5 mL of 2.1 10⁻⁵ M Fe₂(SO₄)₃ aqueous solution were mixed, was prepared. 1.5 mL of the mixture was mixed with 0.1 mL of 0.05% by weight of graphene nano sheet solution. This mixture was strongly stirred for 6 hours to make iron ions absorbed onto surfaces of the graphene nano sheets. The absorbed iron ions were synthesized into iron oxide by oxygen present in the solution. After reaction, the solution was centrifuged, followed by addition of 1.4 mL of distilled water, thereby preparing a dispersion solution. The washing process was repeated three times.

### Example 1

Steps (B) and (C) were carried out merely one time to fabricate a graphene-iron oxide complex.

### Example 2

Steps (B) and (C) were carried out totally three times to fabricate a graphene-iron oxide complex.

### Example 3

Steps (B) and (C) were carried out totally five times to fabricate a graphene-iron oxide complex.

### Fabrication of Purification Filter for Removal of Heavy Metals

### Example 4

The graphene-iron oxide complex fabricated in Example 1 was used to fabricate a purification filter for removal of heavy metals.

### Example 5

The graphene-iron oxide complex fabricated in Example 3 was used to fabricate a purification filter for removal of heavy metals.

Adsorption/Desorption Test for Heavy Metal Ion

For an adsorption/desorption test for heavy metal ions, Na₃AsO₄.12H₂O was used as a source of arsenic, and KwCr₂O₇ was used as a source of chrome. Initial concentrations of the arsenic and the chrome were 71.86 mg/L and 64.45 mg/L, respectively. 0.008 g of graphene-iron oxide complex was added into 25 mL of heavy metal solution to be stirred together. After a predetermined time (5 min, 10 min, 20 min, 40 min, an hour), the graphene-iron oxide complex was separated, and the amounts of arsenic and chrome remaining in the solution were measured by using an inductively coupled plasma mass spectroscopy.

An adsorption capacity of the heavy metal ions was calculated by the following Equation.

qₑ=(Cₒ−Cₑ)V/m

where qₑ denotes an equilibrium concentration of the heavy metal ions in a heavy metal remover, Cₒ denotes an initial concentration of a heavy metal ion is solution, Cₒ denotes an equilibrium concentration of the heavy metal ions, m denotes a mass of an absorbent, and V denotes a volume of the heavy metal ion.

1.4 T of NdFeB magnet was used to separate the graphene-iron oxide complex on which the heavy metal ions were absorbed.

TEM/EDX analysis was carried out using JEOL JEM-2200 FS microscope (200 kV). An ultra-high resolution FE-SEM image was obtained by using Hitachi S-5500 and S-4700 microscopes. Raman analysis was carried out using Nanofinder 30 of Tokyo Instrument Inc. XPS analysis was carried out using Axis NOVA spectroscope from Kratos analytical Ltd., using aluminum cathode at 600 W. XRD analysis was carried out using Rigaku X-ray diffractometer. ICP-MS analysis was carried out using Agilent (USA) model 7500a. BET specific surface area measurement was carried out using a particle size analyzer UPA-150.

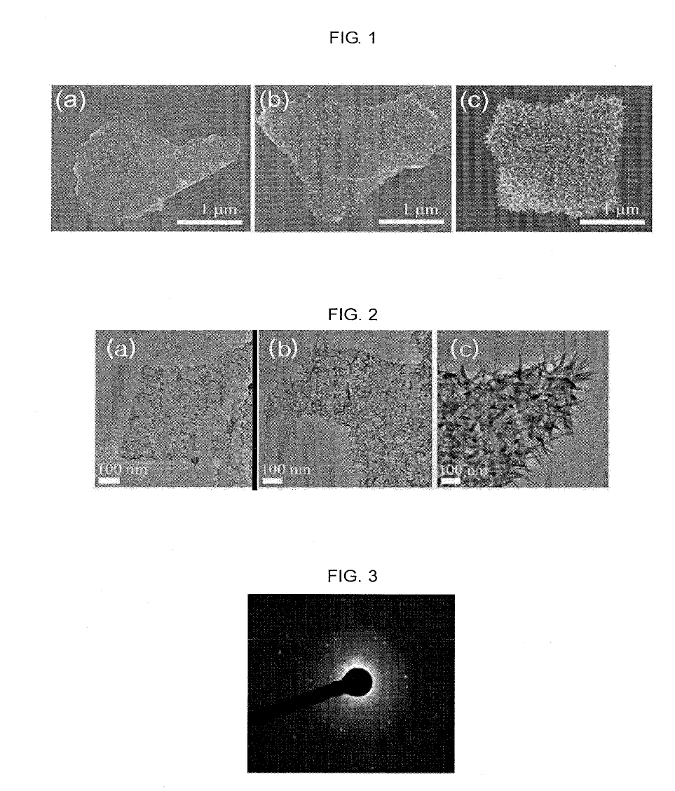

FIG. 1 shows Scanning Electron Microscopic (SEM) photos of graphene-iron oxide complexes fabricated in Examples 1 to 3. FIGS. 1(A), (B) and (C) respectively show that the iron oxide synthesis reaction cycle (steps (B) and (C)) is carried out one time (Example 1), three times (Example 2) and five times (Example 3). It can be noticed from the photos that the needle-like iron oxide nanoparticles synthesized on the surface of graphene become long in length as the iron oxide synthesis reaction cycle is repeated several times. FIG. 2 shows Transmission Electron Microscopic (TEM) photos of the graphene-iron oxide complexes. FIGS. 2(A), (B) and (C) respectively show that the iron oxide synthesis reaction cycle (steps (B) and (C)) is carried out one time (Example 1), three times (Example 2) and five times (Example 3), similar to FIG. 1.

FIG. 3 shows an electron diffraction pattern of a selected area of Example 1, which shows that the graphene configuring the fabricated graphene-iron oxide complex is a thin film in an extremely thin shape with one or two layers.

FIG. 4 shows photos of purification filters for removal of heavy metals fabricated using the graphene-iron oxide complexes. FIG. 4A shows the purification filter for removal heavy metals fabricated in Example 4 and FIG. 4B shows one fabricated in Example 5. Those photos show that when the fabricated graphene-iron oxide complex was filtered using a membrane filter to be made in form of paper, the properties are adjusted according to the length of the iron oxide synthesized on the surface of the graphene. They also show that when the iron oxide synthesis reaction cycle is carried out only one time (FIG. 4A), the length of the needle-like iron oxide nanoparticle is about 30 nm and the graphene flexibility is still maintained. It can also be noticed that when the iron oxide synthesis reaction cycle is carried out five times (FIG. 4B), the length of the needle-like iron oxide nanoparticle is about 220 nm and when the graphene-iron oxide complex was made in form of paper, the graphene flexibility is disappeared to be brittle.

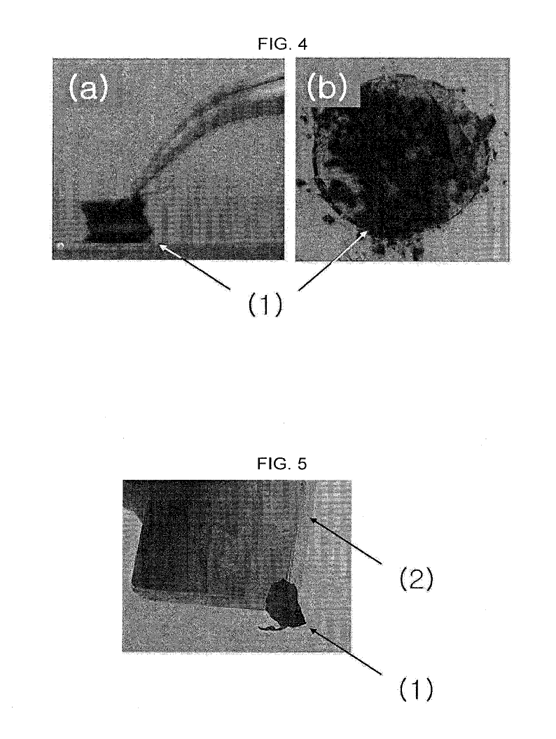

FIG. 5 is a photo showing that the purification filter for removal of heavy metals is stuck to a magnet. The purification filter for removal of heavy metals is stuck to the magnet by superparamagnetism of the iron oxide. This property is useful for separation and collection of heavy metals after adsorption thereof.

Properties of a pure graphene sheet, the graphene-iron oxide complexes of Examples 1 and 3 were shown in Table 1.

| | conductivity | BET surface area | |
|---|---|---|---|
| | (S/m) | (m²/g) | mechanical property |
| Pure graphene | 1732 | 375 | flexible |
| sheet | | | |
| Example 1 | 1134 | 790 | flexible |
| Example 3 | 131 | 1460 | brittle |

The pure graphene sheet exhibits a specific surface area of 375 m²/g. Here, upon fabricating the needle-like iron oxide nanoparticle, Example 1 (the length of needle-like iron oxide nanoparticle: about 30 nm) exhibits specific surface area of 790 m²/g and Example 3 (the length of needle-like iron oxide nanoparticle: about 220 nm) exhibits a specific surface area of 1460 m²/g, from which it can be noticed that the specific surface area is increased. In the meantime, the conductivity of the graphene is gradually decreased as the needle-like iron oxide nanoparticle is formed on the surface thereof.

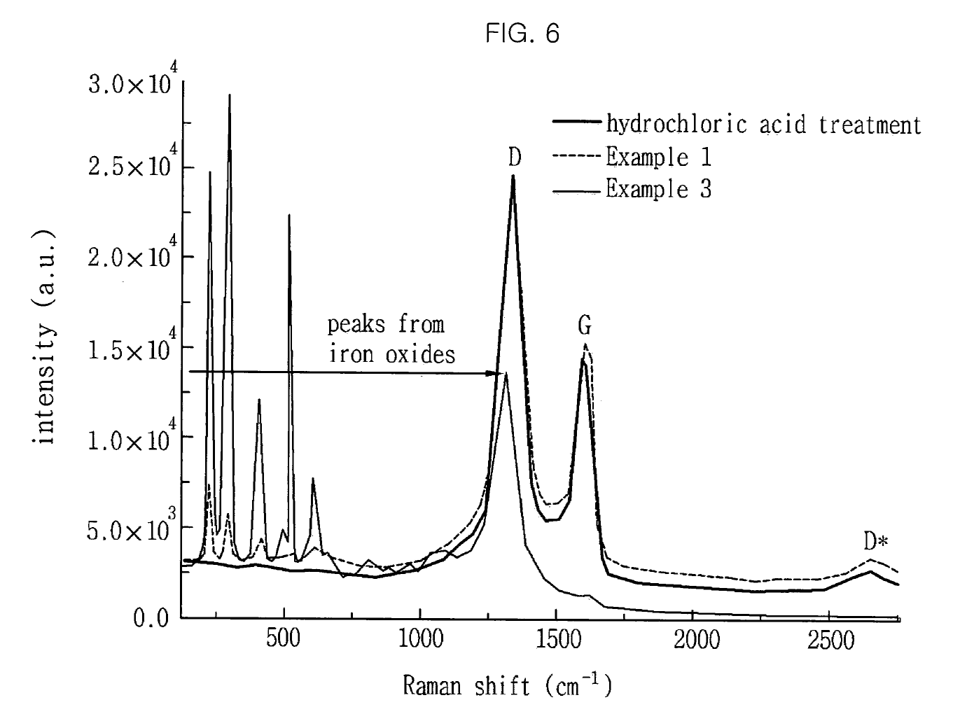

FIG. 6 is a graph showing results of Raman analysis for the graphene-iron oxide complexes. The Raman analysis is carried out to check whether or not the needle-like iron oxide nanoparticles were uniformly grown on the surface of the graphene. Example 1 exhibits D peak, G peak and 2D peak as graphene-specific characteristics. On the contrary, Example 3, in which numerous needle-like iron oxide nanoparticles are formed, exhibits peaks by the iron oxide, without those peaks of the graphene (shielding). When the iron oxide nanoparticles are removed from this sample through treatment with hydrochloric acid (“hydrochloric acid treatment”), D peak, G peak and 2D peak as graphene-specific characteristics were observed again. Accordingly, it can be understood that the needle-like iron oxide nanoparticles are uniformly formed on the entire surface of the graphene.

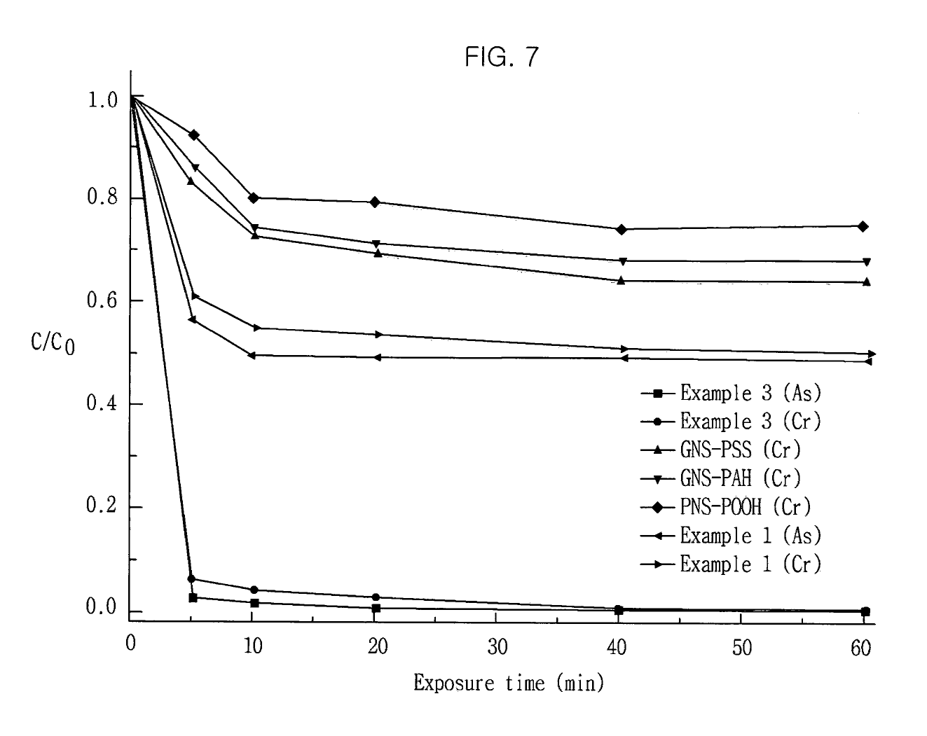

FIG. 7 is a graph showing test results of removal of heavy metals using the graphene-iron oxide complexes. A test for removing arsenic and chrome was carried out. For comparison of performance, a pure graphite oxide and pure graphene sheet were tested as well. 8 mg of sample was exposed to 25 ml of a heavy metal ion solution. For the pure graphite oxide and the graphene sheet, an amount of heavy metals removed were insignificant even after one hour (about 30% at most). On the contrary, the graphene-iron oxide complexes exhibited 50% and 100% of removal of heavy metals, respectively, after one hour (using the graphene-iron oxide complexes of Examples 1 and 3). Especially, the graphene-iron oxide complex of Example 3 exhibited that most of heavy metals were removed within 5 minutes. The removal capacity of heavy metals was 218 mg/g for arsenic and 190 mg/g for chrome. This capacities correspond to the highest values among iron oxide based heavy metal adsorbents, which have already been reported. GNS_PSS(Cr), GNS_PAH(Cr) and GNS_COOH(Cr) in FIG. 7 indicate a graphene sheet coated with polyelectrolyte polystyrene sulfonate, a graphene sheet coated with polyelectrolyte poly(allylamine hydrochloride) and a pure graphene (containing COOH group on surface) that the synthesized graphene sheet is not treated with polyelectrolyte, respectively.

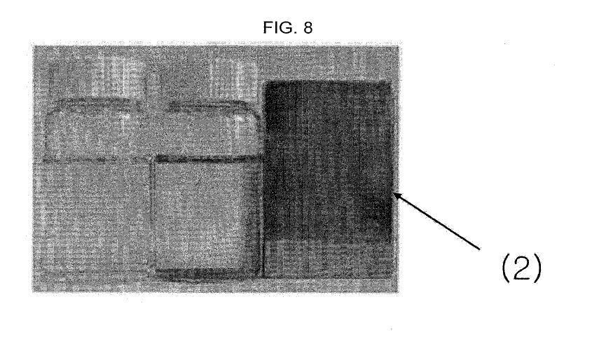

FIG. 8 shows photos showing a process of removing the graphene-iron oxide complex, to which heavy metals are absorbed, using a magnet. It can be noticed from the photos that when a magnet is moved toward a chrome ion solution mixed with the graphene-iron oxide complex (i.e., when forming a magnetic field), the chrome ions are removed, accordingly, a color of the solution, which was originally light yellow, becomes transparent and the graphene-iron oxide complex, onto which heavy metals are absorbed, is attracted to the magnet to be stuck on a surface of glass.

In order to check a heavy metal adsorption/desorption performance, a test for removing lead and chrome ions was carried out. It was checked from the test that most of lead and chrome ions are fast removed within a time shorter than 10 minutes. The removal capacity was 46.6 mg/g for lead and 29.16 mg/g for chrome. It can also be known that the heavy metal remover based on the graphene-iron oxide complex according to this specification can remove lead, palladium, hydrargyrum and the like as well as arsenic and chrome.

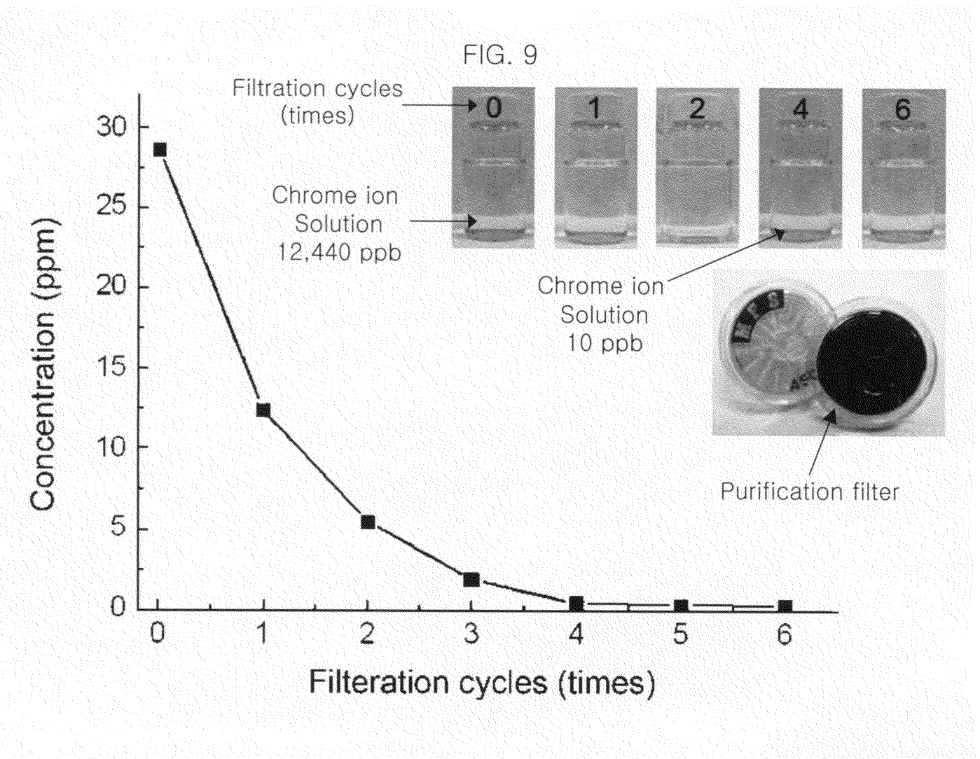

Purification filters for removal of heavy metals were fabricated by using the graphene-iron oxide complexes (Examples 4 and 5). FIG. 9 shows the changes in concentrations of heavy metal ions within a chrome ion solution and related photos when employing the purification filter for removal of heavy metals using the graphene-iron oxide complex. For checking with naked eyes, a heavy metal ion solution with an extremely high concentration was used (chrome ion solution, 12,440 ppb). The numbers 0 to 6 in FIG. 9 indicate filtration cycles (times). It can be seen from the graph that more than half of heavy metals are removed by one-time filtration. After four-time filtration, the concentration of the heavy metal ion was lowered down to 10 ppb, which is a level appropriate for drinking water.

According to those test results, it can be understood that the graphene-iron oxide complex according to the present disclosure can be utilized as a heavy metal ion remover with high efficiency by virtue of its extremely high specific surface area. Also, the flexibility of the graphene and the selective separation characteristic of the iron oxide may act as significant advantages in the aspect of substantial use as a heavy metal remover.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A graphene-iron oxide complex comprising graphene and needle-like iron oxide nanoparticles grown on a surface of the graphene.

2. The complex of claim 1, wherein the needle-like iron oxide nanoparticle is 10 nm to 500 nm in length.

3. The complex of claim 1, wherein the graphene-iron oxide complex has a specific surface area more than 200 m²/g.

4. A purification filter for removal of heavy metals characterized by employing the graphene-iron oxide complex according to claim 1 as a membrane filter.

5. A method for fabricating a graphene-iron oxide complex comprising:
(A) preparing a reduced graphene dispersed solution;
(B) mixing the dispersed solution with a solution containing iron oxide precursors to prepare a mixture;
(C) stirring the mixture to prepare a graphene-iron oxide complex dispersed solution containing the graphene-iron oxide complex that needle-like iron oxide nanoparticles are grown on the surface of the graphene; and
(D) separating the graphene-iron oxide complex from the graphene-iron oxide complex dispersed solution.

6. The method of claim 5, wherein the step (A) is carried out by treating graphite with strong acid to prepare graphite oxide, and executing a treatment with ultrasonic waves and a reduction for the graphite oxide to prepare the reduced graphene dispersed solution.

7. The method of claim 5, wherein the iron oxide precursor is iron pyrite (II) or iron pyrite (III).

8. The method of claim 5, wherein prior to the step (D), the steps (C) and (D) are repeated to facilitate adjustment of a length of the needle-like iron oxide nanoparticle and a specific surface area of the graphene-iron oxide complex.

9. A method for removing heavy metals characterized by bonding the graphene-iron oxide complex, fabricated by the method according to any of claims 5 to 8, to heavy metals contained in contaminated water, forming a magnetic field, and separating the heavy metal-bonded graphene-iron oxide complex.

10. A method for fabricating a purification filter for removal of heavy metal employing the graphene-iron oxide complex, fabricated by the method according to any of claims 5 to 8, as a membrane filter.

11. A method for removing heavy metals characterized by rendering contaminated water containing heavy metals flow through the purification filter for removal of heavy metals, fabricated by the method according to claim 10, in a contact state with each other, so as to remove the heavy metals.
